(19) United States
(12) Patent Application Publication
(10) Pub. No.: US 2006/0167721 A1
(43) Pub. Date: Jul. 27, 2006

(54) Methods for patient care using acuity templates

(76) Inventors: Betty Bernard, Spencerville, MD (US); Vera Cermin Dvorak, McLean, VA (US)

Correspondence Address: FULBRIGHT & JAWORSKI L.L.P., 600 CONGRESS AVE., SUITE 2400, AUSTIN, TX, 78701, US

(21) Appl. No.: 11/322,172

(22) Filed: Dec. 29, 2005

Related U.S. Application Data
(60) Provisional application No. 60/640,586, filed on Dec. 30, 2004.

(51) Int. Cl. G06Q 10/00

(52) U.S. Cl. 705/2

(57) ABSTRACT

Methods for determining a post-acute level of care for a patient are provided. A template is provided, the template including categories indicating issues relating to a condition, such as a neurological event, a wound injury, or an orthopedic injury. Each category includes several levels, each level representing a severity of the category. A numerical rating is assigned to a level selected for each category, and a total score is calculated. Using the template and the score, a care facility is recommended for the patient.

This application claims priority to, and incorporates by reference, U.S. Provisional Patent Application Ser. No. 60/640,586, which was filed on Dec. 30, 2004.

### BACKGROUND OF THE INVENTION

1. Field of the Invention

The present invention relates generally to patient care. More particularly, it concerns using specific templates to determine appropriate levels of care for different diagnostic categories, such as, but not limited to, neurological events, wound care, or orthopedic rehabilitation.

2. Description of Related Art

Quick and accurate evaluations of a patient's condition are critical in determining an appropriate treatment for the patient. Many computer programs, including, for example, Wound and Skin Intelligence System (WSIS) developed by Convatec and Applied Health Sciences have been developed for patient assessment and appropriate clinical treatment or diagnosis. The technique of the above and other conventional methods include having a caregiver ascertain information, such as the patient's medical history and the nature of the ailment, and inputting these parameters into the computer program. The program, equipped with standards and protocols on how to treat conditions or rule out possible diseases, can identify an appropriate treatment based on the parameters and can provide the suggested treatment to the caregiver.

However, the patient's overall recovery process is not assessed. In many cases, patients need follow-up care after the initial treatment. Currently, there is no tool that can consistently and objectively be utilized by nurses, discharge planners, and physicians to determine the appropriate level of care for compromised patients. Additionally, most physicians, while aware of post-treatment facilities, lack the general awareness of the type of treatment and the required time allotment needed from a patient. As such, some patients are unable to fully participate in their needed post-treatment care and thus, may risk further injuries or develop severe conditions requiring readmission to acute care hospitals.

Any shortcoming mentioned above is not intended to be exhaustive, but rather is among many that tends to impair the effectiveness of previously known techniques assessing appropriate treatments for a patient; however, shortcomings mentioned here are sufficient to demonstrate that the methodologies appearing in the art have not been satisfactory and that a significant need exists for the techniques described and claimed in this disclosure.

### SUMMARY OF THE INVENTION

The templates of the present disclosure provide a tool for assessing a patient and determining placement of the patient in care facilities appropriate for the patient's need. Using the templates decreases the need for readmission and improves the recovery process of the patient.

In one respect, the present disclosure involves a method for determining a care facility for a patient. A template which includes a plurality of categories indicating issues relating to a condition of the patient may be provided. The condition may include, for example, a neurological event, wound injury, or an orthopedic injury. Each category includes a level, each level representing the severity of the category. Once a level is selected, a rating for the level may be determined. A score is calculated (e.g., summing the ratings of each category) using the ratings determined for each category. The score can be used to determine an appropriate care facility for the patient.

In other respects, a computer program including instructions for determining a care facility for a patient. The computer program includes instructions for determining a level of a category within a template. The computer program also includes instructions for finding a score of the template and instructions for using the score to determine the care facility for a patient.

The terms “a” and “an” are defined as one or more unless this disclosure explicitly requires otherwise.

The term “substantially,” “about,” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings demonstrate certain aspects of the invention. The drawings illustrate examples only. Identical element numbers are used for convenience only and signify identical or similar structures or functionality. The use of identical element numbers should not be interpreted as signifying the scope of the invention.

FIG. 1 is a flowchart of a method, in accordance with embodiments of this disclosure.

FIG. 2A is a template for neurological assessments of a patient, in accordance with embodiments of this disclosure.

FIG. 2B is a table listing the recommended level of care based on the assessment from FIG. 1A, in accordance with embodiments of this disclosure.

FIG. 3A is a template for wound care assessments of patient, in accordance with embodiments of this disclosure.

FIG. 3B is a table listing the recommended level of care based on the assessment from FIG. 2A, in accordance with embodiments of this disclosure.

FIG. 4A is a template for orthopedic assessments of a patient, in accordance with embodiments of this disclosure..

FIG. 4B is a table listing the recommended level of care based on the assessment from FIG. 3A, in accordance with embodiments of this disclosure.

### DESCRIPTION OF ILLUSTRATIVE EMBODIMENTS

The invention and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The present disclosure provides techniques for quickly and accurately assessing a patient's condition and determining the appropriate level of post-acute hospital care. In some respects, a grading system has been developed. Using specific templates for a particular diagnostic category such as, but not limited to, neurological events, wound care, or orthopedic injuries, caregiver (e.g., nurses, doctors, discharge planners, etc.) can recommend an appropriate facility needed for a patient's recovery. The facility may include inpatient rehabilitation centers (IRCs) which provides multi-disciplinary therapy for patients delivered by a physician-directed care team. These facilities generally work with patients for an extended period of time (e.g., a few hours in a day) to help patients regain daily functions lost or compromised due to a condition or disease. Other facilities may include, without limitation, homecare/outpatient services, inpatient, inpatient community level medical rehabilitation (Comm MR) centers, transitional care units, or skilled nursing facilities (SNFs).

Generally, the admission to a post-treatment facility may be determined by standard protocols. For example, the Center for Medicare and Medicaid Services (CMS) provides diagnostic criteria for IRF admissions. The current condition of a patient, in particular, the independent measures (I/M) may be considered. These parameters may include, for example, self care, bladder and bowel control, mobility, locomotion, communication and social cognition. Other parameters may include the progression of the illness and/or other diseases.

In one embodiment, a template, which addresses domains essential to a patient's recovery, may be provided. The template may include categories that are indicators of the condition and/or disease. The indicators may include the status of the condition/disease, other health issues that may affect the condition/disease, mental status of the patient, mobility of the patient, etc. The categories may also include expected outcomes of the condition and/or disease, as well as expected help needed during treatment and post-treatment, from a psychosocial or social caregiver. For each category, there may be a number of levels. In one non-limiting example, for a mental status category of a patient, four levels may be included: uncooperative, confused, apathetic, and alert. It is understood that other levels may be appropriate in determining the mental status. It is further understood that a template may be tailored for a specific condition and/or disease, and therefore, the number of categories and levels may differ.

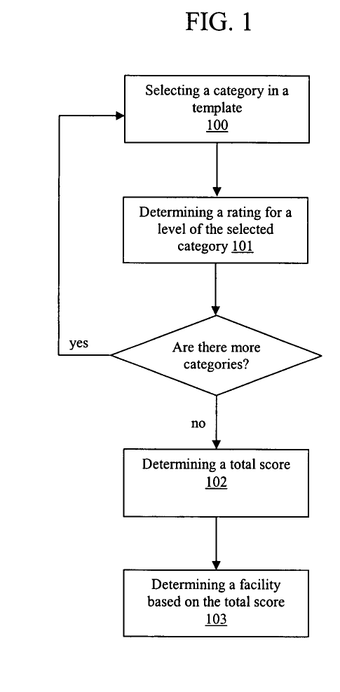

In order to determine the appropriate post-treatment care facility for a patient with a type of condition and/or disease, including, without limitation, neurological event, wound injury, or an orthopedic injury, specific categories correlating to the condition and/or disease are selected from a template, as shown in step 100 of FIG. 1. The categories may include, without limitation, co-morbidity, physical deficit activities daily log (ADL), cognition, incontinence, psychosocial status, and the expected outcome after treatment. Other categories may also be used to determine the treatment and/or post-treatment for the patient. For example, the patient's body mass index (BMI), other ailments, conditions, or diseases, the patient's weight, and/or the severity of present conditions and/or disease may be used to determine the treatment and/or post-treatment needs of the patient.

For each category, a plurality of levels may be provided, where the levels indicate the different progression stages of the category. For example, for the category cognition, levels such as, but not limited to, alert, apathetic, confused, and uncooperative are provided. The patient may be evaluated to determine what level of cognition he or she may exude. Each level may be related to a rating, which may correspond to a numerical rating system based on clinical information within the template may be assigned. In some respect, a number ranging from 4 to 1 may be assigned to each level, where 4 is the lowest level of effect and 1 may by the highest level of effect to the overall assessment and treatment of the patient.

Steps 100 and 101 may be repeated for subsequent categories related to the condition and/or disease. After each category is reviewed, the rating for each category is calculated yielding a total score (step 102). In one embodiment, the ratings for each category are summed together. Based on the score, a care facility may be determined (step 103).

In some embodiments, the rating system and/or categories used to determine treatment may be modified by a caregiver (e.g., nurse, physician, etc.). For example, the rating system may be altered to provide new categories, remove old categories, or apply a different numerical rating systems for post-treatment care. The updated template may be stored on a server and may be available via the Internet. As such, the caregiver may access the server and download the upgraded ratings and/or category listing. Alternatively, the caregiver may manually update the template to include new and/or improved clinical data.

The techniques described in FIG. 1 may be implemented on a processor or any computer-readable media known in the art. A processor or computer-readable, as used and described in this disclosure, may include any computing device capable of executing instructions for receiving clinical information input from a caregiver. For example, the processor or computer-readable media may be a personal computer (e.g., a typical desktop or laptop computer operated by a user). In another embodiment, processor or computer-readable media may be a personal digital assistant (PDA) or other handheld computing device.

Alternatively, the processor or computer-readable media may be a networked device and may constitute a terminal device running software from a remote server, wired or wirelessly. Input from a caregiver or other system components, may be gathered through one or more known techniques such as a keyboard and/or mouse. Output, if necessary, may be achieved through one or more known techniques such as an output file, printer, facsimile, e-mail, web-posting, or the like. In other embodiments, the techniques described in FIG. 1 may be embodied internally or externally on a hard drive, ASIC, CD drive, DVD drive, tape drive, floppy drive, network drive, flash, or the like. Any type of monitor or screen known in the art, for displaying information, such as the templates may be coupled to the processor or computer-readable media. For example, a cathode ray tube (CRT) or liquid crystal display (LCD) can be used. One or more display panels may also constitute a display. In other embodiments, a traditional display may not be required, and processor the processor or computer-readable media may operate through appropriate voice and/or key commands.

### EXAMPLES

The following examples are included to demonstrate specific embodiments of this disclosure. It should be appreciated by those of ordinary skill in the art that the techniques disclosed in the examples that follow represent techniques discovered by the inventors to function well in the practice of the invention, and thus can be considered to constitute specific modes for its practice. However, those of ordinary skill in the art should, in light of the present disclosure, appreciate that many changes can be made in the specific embodiments which are disclosed and still obtain a like or similar result without departing from the spirit and scope of the invention.

Neurological Acuity Templates

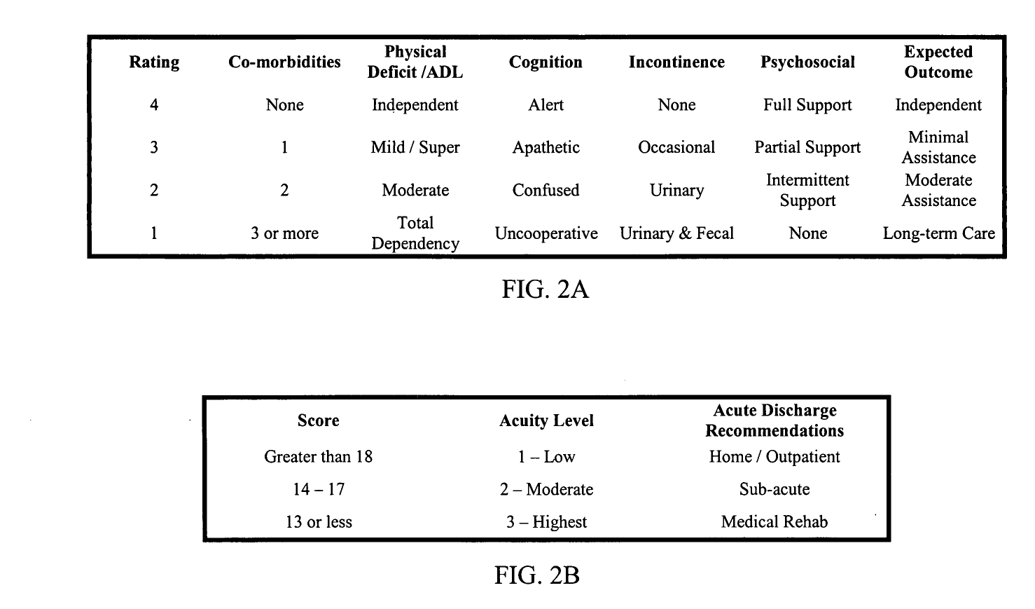

Referring to FIGS. 2A-2B, templates for determining an appropriate level of post-treatment (e.g., acute facility care after discharge and/or initial treatment) for a patient needing neurological care are shown. FIG. 2A illustrates six categories that may relate to the neurological well-being of the patient (e.g., co-morbidities (e.g., other health issues), physical deficits or activities of daily living (ADL), cognition, incontinence, psychosocial or caregiver, and expected outcome). Each category may include four levels, and each level corresponding to a numerical rating. The categories are explained in further details below.

Co-Morbidities

A first category includes co-morbidities. Co-morbidities reflect the overall health of the patient. Co-morbidities may indirectly impact clinical outcomes and the number of co-morbidities contributes to a cumulative risk. In one non-limiting example, for a cerebrovascular accident (CVA), conditions such as hypertension may be significant due to the potential worsening of the event. As such, a caregiver may determine the number of health issues that may relate to the prognosis, treatment, and post-treatment care for a patient. The number of health issues may relate to a rating, ranging between the value of 1 to 4, as shown in FIG. 2A.

Activities of Daily Living

A second category includes physical deficit ADL (Activities of Daily Living) at the time of release may impact the level of rehabilitation, services required to rehabilitate and potential goals of the patient. A patient may be evaluated to determine what level, for example, (Independent, Mild Supervision, Moderate, and Total Dependency) of ADL he or she may exhibit. Patients who require substantially no support, including ambulation may have a independent ADL level. This level of ADL has a rating of 4.

For patients that exhibit mild supervision ADL level (rating of 3), assistance in daily routines and an assistive device for ambulation may be required. These patients may ambulate household distances greater than about 100 ft. and can access bathroom facilities in addition to outside of the residence. For other traveling needs, these patients may be dependent for outside transportation. Additionally, they may require assistance in making and keeping appointments.

If a patient has a moderate ADL level, the patient may require assistance in daily activities. The patient may require help with daily grooming routines, meal preparation, getting dressed, etc. The patient may also have some limited mobility, including, for example, traversing a living area in areas with flatter surfaces and can self-feed with proper set-up. This level of ADL has a rating of 2.

Patients that have a total dependency ADL level may require assistance in most facets of daily living. These patients require aid in, for example, ambulance, grooming, feedings, etc. This level of ADL has a rating of 1.

Cognition

A third category that may be used to evaluate a patient may be cognition, which is an indicator of the level of neurological involvement. A patience who has lost some cognition may require lengthy rehabilitation. Additionally, the steps towards regaining cognition may plateau (e.g., showing signs of little improvement) and thus, affecting the types of services required. In some embodiments, cognition may be reassessed frequently during treatment and goals may be adjusted based on the patient's progression.

The levels for determining cognition include Alert, Apathetic, Confused, and Uncooperative. Alert, having a rating of 1, is where a patient may be capable of high level, complex thoughts. The patient may be aware of himself or herself, place, and the circumstances surrounding him or her.

Patients that are apathetic may be aware of himself or herself, place, and circumstances, but may require cueing and/or emotional support. In some embodiments, a caregiver may label a patient apathetic if the patient is functionally depressed. The apathetic level has a rating of 2.

For those patients who are inconsistent with orientation of self, place, and circumstance, their cognition may be determined to be confused. The patients have some cognitive skills, but lack more complex cognitive. For example, the patients may lack safety awareness. This level of cognition has a rating of 3.

Patients that lack cognitive abilities to participate in daily activities may be labeled as uncooperative. These patients may sometimes be combative. In other cases, these patients may be non-participatory. The uncooperative level of cognition has a rating of 4.

Incontinence

Incontinence may be used to determine the level of neurological involvement. In some respects, incontinence may be divided into two separate categories: urinary function and bowel function. Each of these functions separately may provide different implications. For example, if a patient only has urinary incontinence, health issues, which may not be related to the neurological state of a patient, may be evident, such as an urinary tract infection or kidney infection. As such, depending on the type of incontinence, a rating of 4 to 1 may be assigned to a patient.

Psychosocial

Certain situations, such as assisted living, may affect post-treatment plans. Since neurological events may cause disabilities, assistance both mentally and physically may be required. In one respect, if a patient has at least one person (e.g., family, friend, neighbor, and/or professional nursing staff) willing, capable, and available to assist the patient both physically and mentally on a 24 hour basis, the caregiver may give a rating for the psychosocial category may be 4 (full support). In contrast, for those patients who have no reliable support system, a rating of 1 is assigned.

For patients having a person that can provide full support both mentally and physically, but for about 16 hours a day because of for example, work hours, the patient may receive a rating of 3 (e.g., partial support).

Patients who do not have a live-in caregiver, but may have friends, family, and/or community resources that may check in from time to time, may receive a rating of 2 (e.g., intermediate support). The support may be irregular in schedule and unreliable when emergencies occur.

Expected Outcomes

The expected outcomes category relies on what a caregiver (e.g., neurologist, physiatrist, etc.) feels can be expected in terms of the degree of rehabilitation potential for a patient based on clinical findings and/or professional experience. In one respect, if a patient may experience mild deficits and may function without supervision or support from an assistant, a caregiver may choose the level of the expected outcome to be independent (having a rating of 4).

In other respects, if a patient may traverse inside and outside a home and may be able to prepare simple meals, can feed and groom himself or herself, and perform other ADLs with little or some set-up or preparation by others, a caregiver may characterize the expected outcome to include minimal assistance (having a rating of 3).

For patients that may be able to perform some or all ADLs for most of the day, but require partial periods of assistance, including needing assistance outside of the home, a caregiver may characterize the expected outcome to be maximum assistance (having a rating of 2).

Patients that can not perform daily functions including eating, grooming, and moving about the home, may require long-term care (having a rating of 1). These patients generally have cognitive deficits that prohibit improvement. Many times, these patients have little to no support system and/or supplemental care.

Scoring

To determine the appropriate level of post-treatment service, a scoring process may be performed. For each category, the patient is assessed, and based on the assessment, a rating is determined. In other words, for each column, a selection (e.g., selecting a level) is made and a rating, the corresponding numerical value, is recorded. After determining a selection for each column, the ratings are totaled and a recommended level of care will be obtained. Referring to FIG. 2B, a range of totaled ratings, the acuity level, and the recommended discharge recommendation is provided. For patients with a total rating (e.g., score) of greater than 18, the acute discharge recommendation would be home and/or outpatient care. For patients with a total rating ranging from between 14 and 17, a sub-acute level of care may be recommended. For patients with a total of less than 13, a medical rehabilitation center may be recommended.

In some embodiments, not all six categories may be used to determine appropriate facilities. For example, a single category may be a qualifier for determining the appropriate level of care. In the neurological case, cognition may be a major qualifier since a patient needs to be cognitively intact in order to participate in therapy. Alternatively, other categories defined by a caregiver or clinical data may be used in conjunction with any of the above described categories. As such, the template may be modified to suit particular protocols defined by insurance companies, hospital regulations, or personal preference by a caregiver.

Wound Care Acuity Template

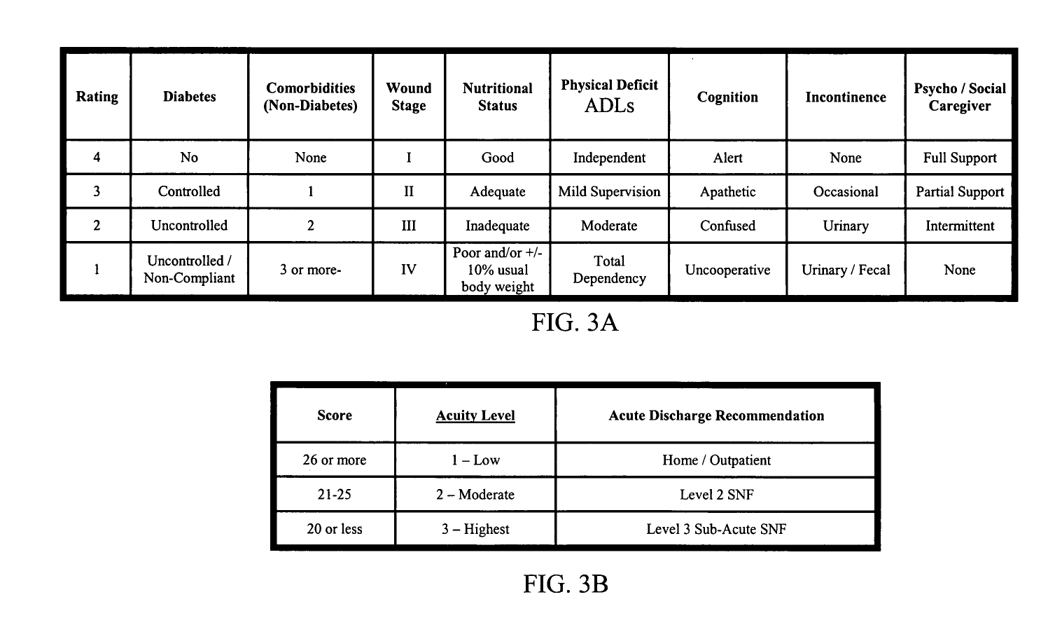

For patients recovering from wound injuries, a wound care acuity template is provided. Referring to FIG. 3A, a plurality of categories may be used to evaluate a patient's needs after post-treatment care. Similar to the neurological acuity templates, a level for the ADL category, non-diabetes co-morbidity (e.g., hypertension, PVD, neuropathy, polyneuropathy, CHF, CAD, cancers, nutritional disorders, multiple sclerosis, paresis, paralysis, etc.) category, cognition category, incontinence category, and psychosocial category may be determined.

In some embodiments, these categories, amongst others, may be tailored to the needs of a wound injury. For example, examining a patient to evaluate what level of ADL he or she can exhibit may help determine if the patient may receive adequate circulation to the area affected.

In other embodiments, incontinence, which may prevent wound areas from being clean and dry and may cause infections, may be evaluated similarly to the neurological acuity template described above and shown in FIG. 3A.

Diabetes

The wound care acuity template may also include a diabetes category. Although, diabetes is a co-morbidity and may be characterized in that category, diabetes may have a direct impact in tissue healing. In one embodiment, the hemoglobin A1C value used to monitor the glucose value of a patient over a period time may be evaluated. For patients that have diabetes, a value of 6 to 7 is considered normal, e.g., the diabetes is under control (having a rating of 3). As such, the wound care acuity template sets a A1C threshold value at 7. Patients that have a A1C value greater than 7, may be ranked as having uncontrolled diabetes (having a rating of 2). For patients with a A1C value that is greater than 7 and is not under the care of a physician, the level selected may be uncontrolled/non-compliant (having a rating of 1).

Nutritional Status

Nutrition and body weight may directly impact wound healing, and as such, the wound care acuity template may evaluate a patient's nutritional status. In some embodiments, the nutritional status includes determining laboratory values for serum albumin, which can indicate the regeneration of tissue and/or the destruction of catabolism leading to necrosis and infection. The normal range for serum albumin can be between about 3.5 to 5.0 g/dl.

Other laboratory tests may include serum total protein which shows if fluids are flowing into cells and reduced colloid osmotic pressure. Generally, the serum total protein may have a normal range of about 6.0 to 8.0 g/dl.

Serum transferrin may also be tested to determine if iron is being transported to plasma, oxygen is being transported to cells, and also if there is collagen synthesis. A normal range of serum transferrin may be in the range of about 180 to 260 ml/dl.

A total lymphocyte count (TLC) may also be determined, where the normal range may be around about 1,500 to about 3,000 cells. TLC may indicate protein status, the state of the immune system, and determine if other factors such as autoimmune diseases, stress, or an infection is prevalent in a patient.

In addition to or alternatively, a patient's body weight may also be evaluated to determine the nutritional status. For example, patients that are overweight may affect wound healing because the skin folds may cause infections in the wound region. As such, in one embodiment, a patient's body weight (plus or minus about 10% of the expected body weight for their build) may be determined.

Patients that have normal lab values and are within a normal body weight range may have a good level of nutritional status and may be assigned a rating of 4 for the category. Patients that have no major weight issues, as defined, for example, by the “Clinical Guidelines on the Identification, Evaluation, and Treatment of Overweight and Obesity in Adults: The Evidence Report”, incorporated by reference in its entirety, and have normal lab values may be rated a 3, an adequate nutritional status.

When issues with body weight (obesity or underweight) and mildly abnormal lab values are evident in a patient, the nutritional status is inadequate, and rating of 2 may be assigned for the category. If lab values are abnormal and issues with body weight are evident, a poor level for the nutritional status is assigned (having a rating of 1).

Wound Stage

The type of wound (e.g., different thickness of tissue) may also impact the length of healing time and need for professional care upon discharge. As such, the wound care acuity template accounts for the type of wounds in a wound stage category having four levels. For wounds that are non-blanchable erythma of intact skin, a stage I is assigned having a rating of 1. Wounds that have partial thickness skin loss involving epidermis or dermis are a stage II would stage with a rating of 2. Stage III is when full thickness skin loss involving necrosis of sub-cutaneous tissues is present in a wound, where stage III has a rating of 3. When a wound has full thickness skin loss with destruction and tissue necrosis or damage to underlying muscle, bone, or supporting structure, the wound is at a stage IV, having a rating of 4.

Scoring

Similar to the scoring process described for the neurological template above, for each category, a level corresponding to the severity of the category is determined. The total ratings after determining a level for each category from FIG. 3A may be summed and used to determine the appropriate acute discharge recommendations, as shown in FIG. 3B. For patients with a score of 21 to 25, a skilled nurse facility (SNF) may be recommended. For patients with a score of 20 or less, a sub-acute SNF may be recommended.

Each category may be weighted, given a numerical significance (e.g., rating) to the impact of each criteria on the potential for successful wound healing. In some embodiments, some of the categories may have a more direct impact on healing and therefore, the rating may be adjusted to compensate for these factors.

Orthopedic Rehabilitation Acuity Template

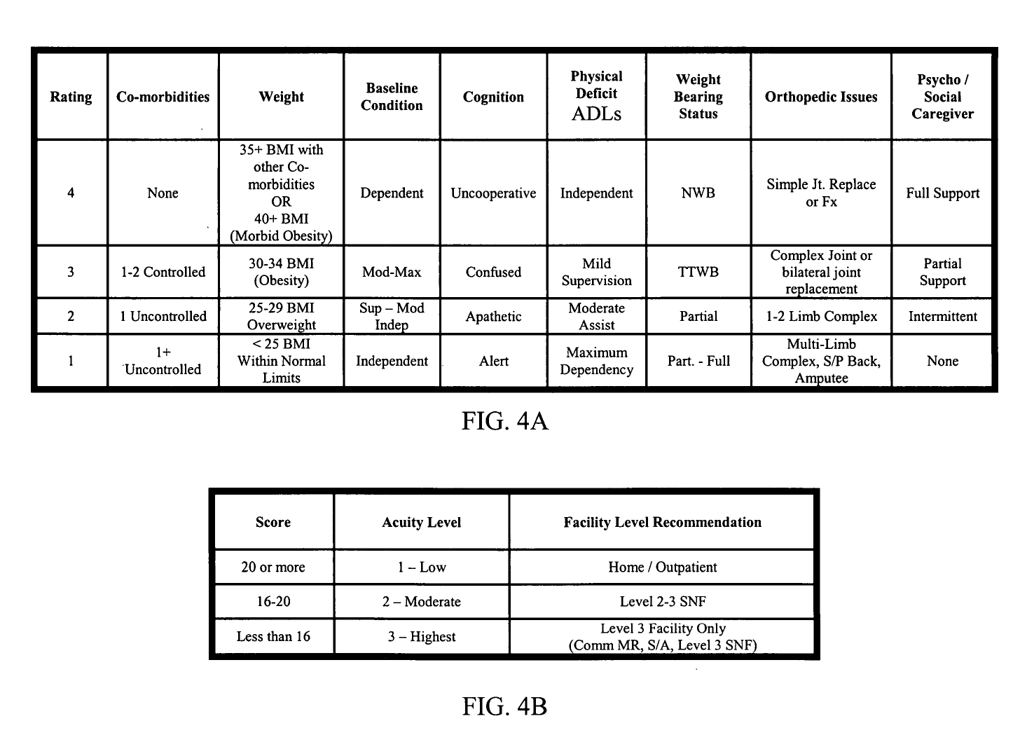

FIGS. 4A-4B show templates including a plurality of categories used to determine a follow-up facility that is appropriate to aid in the rehabilitation of orthopedic patients. The categories, similar to those described in the neurological and wound care templates, include co-morbidities (e.g., cardiac diagnosis, COPD, arthritis issues, neuropathies, multiple sclerosis, paresis or paralysis, and/or neurological events), cognition (e.g., memory deficits), psychosocial or social caregiver, and physical deficits or ADLs.

Weight

The orthopedic rehabilitation acuity template may also include a weight category that may limit gains during rehabilitation, resulting in a prolong treatment. For example, patients that are overweight (e.g., 35+ BMI with co-morbidities or 40+ BMI and no co-morbidities level), rehabilitation may not be appropriate as these patients may not be able to withstand the intense therapy required to rehabilitate the orthopedic injury. In one embodiment, a body mass index (BMI) of patient is evaluated and a rating is assigned accordingly. A patient may range from morbidly obese (35+ BMI and having other co-morbidities or 40+ BMI without co-morbidities) to within a normal limit (25 BMI or less). Depending on what BMI level the patient has, a corresponding rating may be assigned, as shown in FIG. 4A.

Baseline Conditions

The baseline condition category may be used to gauge the level of ADLs of the patient prior to the acute onset of the orthopedic injury or injuries. In one respect, the dependent level, having a rating of 4, corresponds to patients that are dependent for most ADLs, including, for example, bathroom functions, feedings, mobilizing outside of the patient's residence, etc. In contrast, patients that require no support for ADLs including ambulation are at an independent level (rating of 1).

For patients that need moderate to maximum assistance (Mod-Max), a rating of 3 may be given. These patients may require bathroom set-ups, assistance for non-flat ambulation in the residential areas, and may need assistance in dressing. They may also be dependent on meal preparation but may be able to self-feed the meal with some set-up.

Patients that require assistance in the preparation of meals, assistance in higher level of functioning (e.g., reminders for appointments, etc.), and transportation outside of the residence may be at a supine-moderate independent (Sup-Mod Indep) level (rating of 2). These patients can generally perform ADLs, but may be slower in accomplishing the tasks. In some respects, these patient may ambulate household distances (about approximately 100 feet) and can access bathroom facilities using assistive devices.

Weight Bearing Status

The weight bearing status category may determine the type of rehabilitative services rendered to a patient. For example, if a patient cannot bear weight on an extremity that has the orthopedic injury until the extremity is healed, then the patient can only strengthen the areas not directly affected by the event. Thus, the patient participation in rehabilitation may be limited.

In one embodiment, a patient may be at a non-weight bearing (NWB) level where he or she cannot support any direct weight on the injured extremity (rating of 4). He or she may also be limited mobility and may be confined to a bed or chair.

For patients that may bear weight on a portion of their extremity (e.g., a toe, a finger, etc.) but not the entire extremity, their weight bearing status may be at toe touch weight bearing (TTWB) having a rating of 3. The portion of their extremity may be used for stabilization during treatment, but the rehabilitation process is limited.

When light pressure may be applied to the injured extremity, a patient may be at a partial level (rating of 2). Patients who are at a partial-full level are patients who may completely bear weight pressures applied to the extremity with the orthopedic injury (rating of 1).

Orthopedic Issue

In some embodiments, the orthopedic rehabilitation acuity template may include an orthopedic issue category that refers to the type of injury or surgery that may affect the rehabilitation of the patient. Issues such as the nature of the injuries or the type and/or number of surgeries involved may be accounted for when determining rehabilitation centers.

Generally, simple joint involvement such as knee and hip replacements can be rehabilitated in for example, an outpatient environment (rating of 4). In comparison, complex joint replacements or bilateral joint replacement surgeries which require multiple surgeries may require additional, short-term services in a skilled nursing facility to ensure stability during rehabilitation (rating of 3). Additionally, these patients run a higher risks of infections and thus, require extra care.

Patients that undergo one to multiple limb surgeries or have multiple limb fractures may require a complex treatment plan and higher level of expertise (rating of 2). Similarly, patients that have multiple surgeries in areas such as back surgeries or limb amputation, rehabilitation may require a multi-disciplinary approach (rating of 1).

Scoring

After the ratings for each category is determined and a totaled rating is calculated, a facility level may be recommended using FIG. 4B. Home and/or outpatient care facility may be suggested for patients who scored above 20. For patients with a score of 26 or more, home (e.g., long term care) and/or outpatient care may be recommended. These patients may have severe trauma and/or surgery to their extremities or back and may not be able to participate in therapy after their surgeries or treatment. For patients who scored between 16 and 20, a skilled nursing facility (SNF) may be recommended. For patients who scored less than 16, a sub-acute (S/A), SNF or a community medical rehabilitation (Comm MR) center may be recommended.

In some embodiments, the categories may be weighted, giving numerical significance to the impact of each criteria on the potential for orthopedic rehabilitation. Some of the categories may have more direct impact on rehabilitation and therefore the “rating” has been adjusted to compensate for these factors. For example, if a patient has previously had a stroke and the left side of the body is flaccid, and presently has had knee surgery, then the expectation of full rehabilitation is not as likely or at least would influence the patient's rehabilitation, and therefore has a direct impact on rehabilitation.

The above techniques and non-limiting examples provide an overall assessment of a patient to best determine appropriate levels of post-hospital placement. The assessment may take into account proven clinical data which may be updated manually or dynamically to allow for optimal care. The assessment may also account for criteria set forth by medical insurance companies and/or Medicare.

All of the methods disclosed and claimed can be made and executed without undue experimentation in light of the present disclosure. It will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

### REFERENCES

Each of the following references is incorporated by reference in its entirety:
U.S. Pat. No. 6,193,654
U.S. Patent Application No. 20030182163
U.S. Patent Application No. 20040078231
W.O. Patent Application No. 0169515
W.O. Patent Application No. 0241761
W.O. Patent Application No. 0041714
Kramer, A M, Steiner, J F, Schleuker, R E, et al. Outcomes and costs after hip fracture and stroke: A Comparison of Rehabilitation Settings. JAMA 1997:277:396-204.
Esselman, P C. Inpatient Rehabilitation Outcome Trends: Implementation for the Future. JAMA Oct. 13, 2004, Vol. 292, No. 14.
Wadden et al. Clinical Guidelines on the Identification, Evaluation, and Treatment of Overweight and Obesity in Adults: The Evidence Report. The Guilford Press, 2002.

What is claimed is:

1. A method for determining a care facility for a patient, comprising:
providing a template including a co-morbidities category, an incontinence category, a cognition category, a psychosocial category, and an activity daily living (ADL) category;
determining a level for each category, the level indicating the severity of the category;
determining a rating for each level;
calculating a score for the template using the rating; and
determining a care facility appropriate for the condition of the patient from the score.

2. The method of claim 1, where providing a template comprises providing a neurological template, a wound care template, or a orthopedic template.

3. The method of claim 1, the categories further comprising a baseline condition category, a weight bearing category, a weight category, and an orthopedic issue category.

4. The method of claim 3, where providing a template comprises providing an orthopedic template.

5. The method of claim 1, the categories further comprising a diabetes category, a nutritional status category, and a wound stage category.

6. The method of claim 3, where providing a template comprises providing a wound care template.

7. The method of claim 1, the categories further comprising an expected outcome category.

8. The method of claim 7, where providing a template comprises providing a wound neurological template.

9. The method of claim 1, the care facility being selected from the group consisting of a home, outpatient services, inpatient tertiary medical rehabilitation centers, inpatient community level medical rehabilitation centers, transitional care units, and skilled nursing facilities.

10. A computer program, comprising computer or machine-readable program elements translatable for implementing the method of claim 1.

11. A method for determining a care facility for a patient, comprising:
providing a template including a plurality of categories which indicate issues related to a neurological event of the patient;
determining a level for each category, the level indicating the severity of the category;
determining a rating for each level;
calculating a score for the template using the rating; and
determining a care facility appropriate for the patient from the score.

12. The method of claim 11, the categories being selected from a group consisting of co morbidities of the patient, physical deficits of the patient, cognition of the patient, incontinence status of the patient, presence of a caregiver, and an expected outcome.

13. A computer program, comprising computer or machine-readable program elements translatable for implementing the method of claim 11.

14. A method for determining a care facility for a patient, comprising:
providing a template including a plurality of categories which indicate issues related to a condition of a wound of the patient;
determining a level for each category, the level indicating the severity of the category;
determining a rating for each level;
calculating a score for the template using the rating; and
determining a care facility appropriate for the patient from the score.

15. The method of claim 14, the categories being selected from the group consisting of diabetes status of the patient, co morbidities of the patient, physical deficits of the patient, nutritional status of the patient, cognition of the patient, incontinence status of the patient, wound stage, and presence of a caregiver.

16. A computer program, comprising computer or machine-readable program elements translatable for implementing the method of claim 14.

17. A method for determining a care facility for a patient, comprising:
providing a template including a plurality of categories which indicate issues related to an orthopedic condition of the patient;
determining a level for each category, the level indicating the severity of the category;
determining a rating for each level;
calculating a score for the template using the rating; and
determining a care facility appropriate for the patient from the score.

18. The method of claim 17, the categories being selected from the group consisting of diabetes status of the patient, co morbidities of the patient, physical deficits of the patient, cognition of the patient, weight in terms of body mass index of the patient, baseline conditions, weight bearing status of the patient, orthopedic issue of the patient, and a presence of a caregiver.

19. A computer program, comprising computer or machine-readable program elements translatable for implementing the method of claim 15.
